(19) United States
(12) Patent Application Publication
(10) Pub. No.: US 2005/0142321 A1
(43) Pub. Date: Jun. 30, 2005

(54) Glass substrate for magnetic disks and process for its production

(75) Inventors: Osamu Miyahara, Tokyo (JP); Masami Kaneko, Tokyo (JP); Kazuo Mannami, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI GLASS COMPANY, LIMITED, TOKYO (JP)

(21) Appl. No.: 11/013,693

(22) Filed: Dec. 17, 2004

(30) Foreign Application Priority Data
Dec. 19, 2003 (JP) 2003-422711

(51) Int. Cl. B05D 3/04; B32B 3/02

(52) U.S. Cl. 428/64.2; 427/307; 427/372.2; 428/66.6

(57) ABSTRACT

A glass substrate for magnetic disks, which is a doughnut-type glass substrate with its inner peripheral edge surface etching-treated, wherein the etching-treated inner peripheral edge surface is coated with a silicone resin or a polyimide.

The present invention relates to a glass substrate for magnetic disks having high strength and a process for its production.

As a substrate for magnetic disks to be used for e.g. magnetic disk memory devices, an aluminum alloy substrate has been mainly employed. However, along with the demand for high density recording, a glass substrate has now been employed which is excellent in flatness and smoothness and of which the base material itself is hard as compared with an aluminum alloy substrate. However, a glass substrate for magnetic disks, made of glass which is a brittle material, is likely to break during handling or during use, which is regarded as one of the problems.

One of factors governing the mechanical strength of a doughnut-type glass substrate for magnetic disks, is scars which are present on the inner peripheral edge surface of the glass substrate where the maximum tensile stress will be exerted during use of the magnetic disks. In a glass substrate for magnetic disks, it is common that the surface roughness of the inner peripheral edge surface and the outer peripheral edge surface (hereinafter sometimes generally referred to as the inner and outer peripheral edge surfaces) is coarse as compared with the main surface (the surface other than the inner and outer peripheral edge surfaces) required to have very high levels of flatness and smoothness. Namely, the inner and outer peripheral edge surfaces are cut surfaces formed by cutting or coring a disk out of a glass plate and forming a hole at the center, and they are not concerned with the magnetic recording. Besides, they are curved surfaces, which require a high cost for finish processing, whereby finish processing can not adequately be carried out.

In order to reduce the depth of scars on the inner and outer peripheral edge surfaces and thereby to improve the mechanical strength, finish processing of the inner and outer peripheral edge surfaces is carried out with abrasive grains finer than #500 mesh, but considerably deep scars may still remain on the inner and outer peripheral edge surfaces. In order to improve the finishing of the inner and outer peripheral edge surfaces, that is, in order to decrease the roughness, multi-step processing is required by means of abrasive grains having stepwisely reduced grain sizes. However, such multi-step processing has a problem that productivity will thereby be substantially deteriorated, and the cost remarkably increases.

Heretofore, it has been common to employ a chemical reinforcing method so-called an ion exchange method rather than improving the finishing of the inner and outer peripheral edge surfaces in order to improve the mechanical strength of the glass substrate for magnetic disks. The chemical reinforcing method is a method wherein glass is dipped in a molten salt containing K such as a molten potassium nitrate salt to ion exchange Na ions on the glass surface with K ions of the molten potassium nitrate salt to form a compressive stress layer on the glass surface thereby to improve strength of the glass (JP-B-3-52130).

However, the improvement of strength of the glass substrate for magnetic disks by the chemical reinforcing method may be aimed only against a glass substrate containing a predetermined proportion of Na or Li.

The depth of the surface compressive stress layer introduced to the glass surface by such a chemical reinforcing method and the degree of the compressive stress, can be changed to some extents by such conditions as the temperature of the molten salt and the dipping time, and the strength may be increased by increasing the temperature of the molten salt or by prolonging the dipping time. However, in reality, they depend more largely on the composition of the glass itself. Namely, in order to obtain a deep compressive stress layer and thereby to obtain high strength, it is usually necessary to increase the content of Na or Li in the glass composition.

On the other hand, in a magnetic disk, a very thin metal or alloy magnetic film is formed on the surface of the glass substrate, and if an alkali metal component such as Na in the glass increases, there will be a problem that the magnetic film may be corroded by such an alkali metal component.

To overcome this problem, it is conceivable to form, beneath the magnetic film, a primer layer to prevent the alkali metal component from entering into the magnetic film (JP-A-63-112819). However, in such a case, it is required to make the primer layer sufficiently thick, and especially when the glass contains a large amount of such an alkali metal component, it is necessary to make the thickness of the primer layer substantially thick. Further, if such a primer layer is formed on a doughnut-type glass substrate surface by sputtering or vacuum vapor deposition, it is rather difficult to form a primer layer having a sufficient thickness on the inner and outer peripheral edge surfaces, whereby the magnetic film in the vicinity of the inner and outer peripheral edge surfaces tends to be susceptible to corrosion.

In order to prevent such corrosion of the magnetic film by an alkali metal component, it is preferred to employ a glass having a low alkali metal content.

On the other hand, if the amount of Li or Na in the glass is reduced, the depth of the compressive stress layer on the glass surface formed by ion exchange tends to be small and is likely to be smaller than the depth of scars which are present on the glass surface. Accordingly, there has been a problem that the effect of chemical reinforcement is small, and no adequate strength can be obtained.

Further, a glass substrate for magnetic disks, is excellent also in that the rigidity of the glass substrate is high, and the plate thickness can be made thin.

However, if the plate thickness of the glass substrate is thin, when the depth of the surface compressive stress layer formed by the chemical reinforcing method becomes excessive, a large tensile stress will be formed at the center in the thickness direction of the glass substrate, whereby the strength tends to rather decrease.

Further, in the chemical reinforcing method, glass is dipped usually in a molten salt at a temperature of at least 450° C., whereby the glass surface tends to be stained with the molten salt, and it is necessary to carry out polishing after the chemical reinforcing treatment in order to remove the molten salt. In addition, the flatness of the glass substrate is likely to be deteriorated since the chemical reinforcing has to be carried out at a high temperature of at least 450° C.

Further, the chemical reinforcing method has such a problem that in a step of forming a magnetic film by sputtering in a process for producing a magnetic disk, if heating of the glass substrate for magnetic disks is required, the surface compressive stress on the substrate introduced by the chemical reinforcing may undergo stress relaxation when the substrate is heated, and the strength decreases in some cases. This phenomenon is remarkable, for example, when heating to a temperature of at least the strain point of the glass substrate is required. For example, in a process of forming a perpendicular magnetic film, the glass substrate is heated at a high temperature of at least the temperature at which the glass substrate is subjected to the chemical reinforcing treatment in some cases, and there will be problem of stress relaxation.

On the other hand, a hydrofluoric acid etching treatment is widely known as a surface treating method for glass products in general. However, conventional hydrofluoric acid etching treatment is considered to be undesirable against a glass substrate for magnetic disks, since excessive etching treatment is likely to form high projections on the surface of the glass substrate. Namely, in a magnetic disk memory device, a magnetic head flies at a height of from 10 to 50 nm distanced from the magnetic disk surface which rotates at a high speed. Accordingly, high projections formed by excessive etching are likely to create head crash and lead to breakage of the entire recording surface of the magnetic disk.

As a glass substrate to solve the above mentioned problems, JP-A-2-301017 discloses a glass substrate for information recording disks, wherein a continuous layer of an oxide or a continuous layer composed mainly of an oxide having a thickness of from 0.2 to 50 μm, is formed on the inner peripheral side surface or on the inner peripheral side surface and the surface portion along the inner periphery.

It is disclosed that such a continuous layer of an oxide or a continuous layer composed mainly of an oxide preferably contains at least one member selected from Si, Ti, Al and Zr. Further, it is described to be effective to provide such a continuous layer after subjecting a circular processed glass substrate for magnetic disks to etching with hydrofluoric acid or buffered hydrofluoric acid or to leaching with sulfuric acid or nitric acid with a view to removing scars.

Further, it is disclosed that for the formation of the continuous layer, it is necessary to employ a so-called wet process wherein coating is carried out in the form of a solution or a slurry, followed by drying and heat treatment to obtain a cured film. Further, the same publication discloses an Example wherein a SiO₂ continuous layer having a thickness of 2 μm is formed on a glass disk surface by means of a colloidal silica dispersed in ethanol and a sol prepared by hydrolyzing ethyl silicate with an aqueous nitric acid solution, and an Example wherein a SiO₂ continuous layer partially containing an organic group having a thickness of 5 μm, is formed on a glass disk surface by means of monomethyltrimethoxysilane, water glass-type colloidal silica and acetic acid.

However, in the continuous layer disclosed in JP-A-2-301017, water and organic substances are likely to remain. If a glass substrate having such a continuous layer formed on the surface, is introduced into a vacuum process for the production of a magnetic disk, generation of gas is likely to occur due to the water and organic substances remaining in the continuous layer thereby to deteriorate the properties of the magnetic film. Further, in order to form the continuous layer, highly precise adjustment of the viscosity and the pH of the coating liquid has been required, and there has been a problem from the view point of the operation efficiency.

As a glass substrate to solve the above problems, JP-A-11-328665 discloses a glass substrate for magnetic disks produced, for example, in such a manner that a coating composition containing a polysilazane is coated and cured on the etching-treated inner peripheral edge surface of a doughnut-type glass substrate to form a protective film having a hardness corresponding to a pencil scratch value of at least 5H, and then the main surface of the doughnut-type glass substrate is polished.

The polysilazane is brittle and has a higher heat shrinkage ratio than glass, and it thereby generates a stress on the glass substrate when it is fired and the film is cured, and the generation of the stress tends to decrease the strength of the glass substrate.

It is an object of the present invention to provide a glass substrate for magnetic disks having high strength, whereby the above-described problems can be solved, and a process for its production.

The present invention provides a glass substrate for magnetic disks, which is a doughnut-type glass substrate with its inner peripheral edge surface etching-treated, wherein the etching-treated inner peripheral edge surface is coated with a silicone resin or a polyimide resin.

The present invention further provides a glass substrate for magnetic disks, which is a doughnut-type glass substrate with its inner peripheral edge surface and outer peripheral edge surface etching-treated, wherein the etching-treated inner peripheral edge surface and outer peripheral edge surface are coated with a silicone resin or a polyimide resin.

The present invention further provides a process for producing a glass substrate for magnetic disks, which comprises subjecting at least the inner peripheral edge surface of a doughnut-type glass substrate to etching treatment, and then coating the etching-treated inner peripheral edge surface of the doughnut-type glass substrate with a silicone resin or a polyimide resin.

The present invention further provides a process for producing a glass substrate for magnetic disks, which comprises subjecting at least the inner peripheral edge surface and the outer peripheral edge surface of a doughnut-type glass substrate to etching treatment, and then coating the etching-treated inner peripheral edge surface and outer peripheral edge surface of the doughnut-type glass substrate with a silicone resin or a polyimide resin.

The present invention still further provides a process for producing a glass substrate for magnetic disks, which comprises coating a coating composition containing a silicone resin or a polyimide resin, on at least the inner peripheral edge surface of a doughnut-type glass substrate having at least its inner peripheral edge surface etching-treated, followed by curing to form a protective film, and polishing the main surface of the doughnut-type glass substrate.

According to the present invention, a glass substrate for magnetic disks having sufficient strength which requires no chemical reinforcing and a process for its production can be provided.

The coating liquid of the present invention, i.e. a coating composition containing a silicone resin or a polyimide is excellent in operation properties since there are small restrictions regarding the coating conditions such as the pH and the temperature of the coating liquid in the present invention. The restrictions against a protective film forming device are also small due to small restrictions on the operation, and accordingly the device can be selected from a wide range.

Further, when heating at a high temperature is required at the time of formation of a magnetic film by sputtering in a process for producing a magnetic disk, there has been such a problem that the compressive stress introduced to the glass substrate may be relaxed in the case of improvement of strength by the chemical reinforcing method, whereby the strength tends to decrease. However, the present invention is free from such a problem.

The doughnut-type glass substrate of the present invention is a doughnut-type, i.e. a glass substrate having a circular disk shape with a predetermined radius and a glass substrate having a shape such that a circle having the same center as the center of the disk is cored out at a center portion of the disk, and having an inner peripheral edge surface, an outer peripheral edge surface and front and back main surfaces.

The dimensions of the doughnut-type glass substrate are not particularly limited, and the dimensions as represented by mm may, for example, be such that (a) inner diameter 20, outer diameter 65, plate thickness 0.635, (b) inner diameter 25, outer diameter 84, plate thickness 0.635, (c) inner diameter 25, outer diameter 95, plate thickness 0.8, (d) inner diameter 25, outer diameter 84, plate thickness 1.0, or (e) inner diameter 25, outer diameter 95, plate thickness 1.0.

Of the glass substrate for magnetic disks of the present invention, at least the inner peripheral edge surface of the doughnut-type glass substrate is treated by etching treatment, and at least the etching-treated inner peripheral edge surface is covered with a protective film formed by a silicone resin or a polyimide resin. Thus, the inner peripheral edge surface is protected from scratching, and the inner peripheral edge surface is smoothened.

For the etching treatment, a common etching method for glass, such as a wet etching method by means of an etching liquid or a dry etching method by means of an etching gas, may, for example, be used. Among them, a wet etching method employing an etching liquid such as a hydrofluoric acid solution, a hydrofluoric sulfuric acid solution or silicofluoric acid, can be suitably employed. Particularly preferred is a method employing a hydrofluoric sulfuric acid solution. As such an etching treatment, a method of dipping a doughnut-type glass substrate in an etching treatment liquid is common, however, a spray method or another treatment method may be employed. It is essential to apply the etching treatment to the inner peripheral edge surface of the doughnut-type glass substrate. However, it is preferably applied to both inner peripheral edge surface and outer peripheral edge surface. Such etching treatment is carried out preferably within a range not to form high projections on the glass substrate surface by excessive etching.

Further, it is preferred to carry out finish processing on the inner and outer peripheral edge surfaces, particularly the inner peripheral edge surface, of the doughnut-type glass substrate, with abrasive grains of from #200 to #1000 mesh, prior to the etching treatment. Further, as the case requires, chamfering is applied to the inner and outer peripheral edges of the doughnut-type glass substrate. Further, it is more preferred to carry out mirror finish processing on the inner and outer peripheral edge surfaces and the chamfered surfaces at the inner and outer peripheral edges with an abrasive such as cerium oxide.

By the etching treatment, it is possible to remove deep scars present on the inner and outer peripheral edge surfaces, which govern the bending strength of the doughnut-type glass substrate, particularly deep scars on the inner peripheral edge surface, which more strongly govern the bending strength.

The etching amount on the surface of the glass substrate by the etching treatment, i.e. the etching depth which is the thickness of the glass surface removed by the etching treatment, is preferably from 8 to 40 μm. If the depth is less than 8 μm, removal of deep scars present particularly on the inner peripheral edge surface tends to be inadequate, whereby the mechanical strength tends to be low. If it exceeds 40 μm, high projections are likely to form on the glass substrate surface.

As one specific example of the protective film, a film obtained by curing a coating composition containing a silicone resin (hereinafter referred to as a silicone resin type coating composition) may be used. In the molecular structure of the silicone resin, the siloxane bond which forms the main skeleton has a high bond energy, whereby the silicone resin has a high thermal decomposition temperature and is thereby very excellent in heat resistance. Resultingly, a gas is less likely to be generated by heating even if there is a step of heating the substrate in the process for producing a magnetic disk, and properties of the magnetic disk are less likely to be lowered. Further, the silicone resin is ductile as compared with a polysilazane, whereby the stress generated on the glass substrate tends to be small as compared with a case of using the polysilazane, and the strength of the substrate is less likely to be lowered.

It is preferred that the difference between the heat shrinkage ratio of the glass substrate and the shrinkage ratio of the silicone resin is small. Further, it is more preferred that the heat shrinkage ratio of the silicone resin is higher than the heat shrinkage ratio of the glass substrate.

The silicone resin is roughly classified into a straight silicone resin employing properties of the silicone itself and a modified silicone resin having various characteristics of another resin added by modification. Further, the straight silicone resin is classified into a methyl silicone resin and a methylphenyl silicone resin, and as representative examples of the modified silicone resin, alkyd modification, epoxy modification, acrylic modification and polyester modification may, for example, be mentioned, and they may be used as a silicone resin in the present invention.

Among the above silicone resins, a straight silicone resin is particularly desirable in a present invention in view of excellent flame retardant properties. Further, among straight resins, a methylphenyl silicone resin is particularly preferred in the present invention in view of particularly excellent flame retardant properties.

As another specific example of the protective film, a film obtained by curing a coating composition containing a polyimide resin (hereinafter referred to as a polyimide resin type coating composition) may be used. The polyimide resin has a particularly high heat resistance among organic polymers and has flame retardant properties, strength characteristics and dimensional stability, and therefore it is very suitable as a protective film for an inner peripheral edge surface and further for an outer peripheral edge surface of a glass substrate for magnetic disks.

It is preferred that the difference between the heat shrinkage ratio of the glass substrate and the shrinkage ratio of the polyimide resin is small. Further, it is more preferred that the heat shrinkage ratio of the polyimide resin is higher than the heat shrinkage ratio of the glass substrate.

The silicone resin type coating composition usually contains a solvent in addition to the silicone resin. Further, it may contain a catalyst or other additives in addition to the solvent. Further, similarly, the polyimide resin type coating composition usually contains a solvent and may contain a catalyst or other additives in addition to the solvent.

The thickness of the protective film obtained by curing the above curable coating composition is preferably at least 0.5 μm. If it is less than 0.5 μm, the effect of improving the scar resistance may be insufficient. The more preferred thickness of the protective film obtained by curing the curable coating composition is at least 1.0 μm, particularly preferably at least 2.0 μm.

The process for producing a glass substrate for magnetic disks of the present invention is characterized by applying the above etching treatment to at least the inner peripheral edge surface of a doughnut-type glass substrate, and then covering at least the inner peripheral edge surface with a protective film.

Covering of the inner peripheral edge surface, or the inner peripheral edge surface and the outer peripheral edge surface, of the doughnut-type glass substrate, with the silicone resin type coating composition or the polyimide resin type coating composition, is carried out preferably by coating a coating liquid of the coating composition by means of a coating method, followed by curing by e.g. firing to obtain a protective film. When coating is carried out, it is essential to coat the inner peripheral edge surface. It is more preferred to coat the outer peripheral edge surface as well. In such a case, the coating liquid may also be present on the main surface side peripheral to the inner peripheral edge surface or the outer peripheral edge surface beyond the inner peripheral edge surface or the inner and outer peripheral edge surfaces.

As the coating method, the following methods may, for example, be mentioned.

(1) A brush coating method wherein coating is carried out on the inner peripheral edge surface, or on the inner peripheral edge surface and the outer peripheral edge surface, by means of a brush.

(2) A roller coating method wherein the coating liquid is supplied to a porous surface of a roller brush made of e.g. a foamed plastic, and the roller of the roller brush is rotated at a rotational speed of from 10 to 60 rpm, so that it is brought in contact with the inner peripheral edge surface, or the inner peripheral edge surface and the outer peripheral edge surface, of the doughnut-type glass substrate to transfer and coat the coating liquid. In this case, it is preferred that the doughnut-type glass substrate is also rotated at a rotational speed of from 30 to 50 rpm as vacuum-adsorbed.

(3) A direct coating method wherein the doughnut-type glass substrate is vacuum-adsorbed and rotated at a rotational speed of from 10 to 200 rpm, and a predetermined amount of the coating liquid is supplied from a dispenser and coated on the inner peripheral edge surface, or on the inner peripheral edge surface and the outer peripheral edge surface.

(4) A spray method wherein the doughnut-type glass substrate is rotated at a rotational speed of from 5 to 50 rpm, and the coating liquid sprayed by a spray nozzle is supplied and coated on the inner peripheral portion, or the inner peripheral edge surface and the outer peripheral portion.

The type of glass to be used for the glass substrate for magnetic disks of the present invention is not particularly limited, but for the improvement of the weather resistance, a glass having the following characteristics is preferred.

Water resistance: When the glass is immersed in water of 80° C. for 24 hours, the weight reduction of the glass (eluted amount) due to elution of components from the glass, is not more than 0.02 mg/cm².

Acid resistance: When the glass is immersed in a 0.1 N hydrochloric acid aqueous solution of 80° C. for 24 hours, the weight reduction of the glass (eluted amount) due to elution of components from the glass, is not more than 0.06 mg/cm².

Alkali resistance: When the glass is immersed in a 0.1 N sodium hydroxide aqueous solution of 80° C. for 24 hours, the weight reduction of the glass (eluted amount) due to elution of components from the glass is not more than 1 mg/cm, more preferably not more than 0.18 mg/cm².

In the present invention, it is not required to use a chemical reinforcing method, and there is no lower limit in the content of an alkali metal such as Na or Li as the composition of the glass with a view to making chemical reinforcement possible. The glass which may be used for the glass substrate for magnetic disks of the present invention, may, for example, be a glass having an alkali metal oxide content of from 1 to 20 wt %, such as soda lime silica glass, alumina silicate glass, alkali-free glass or crystallized glass.

Now, the present invention will be described in further detail with reference to Examples. However, it should be understood that the present invention is by no means restricted to such specific Examples.

### EXAMPLE 1

A doughnut-type glass substrate having an outer diameter of 65 mm, an inner diameter of 20 mm and a thickness of 0.9 mm was prepared which was made of glass A having a composition comprising, as calculated as oxides, 56.0 mass % of SiO₂, 6.0 mass % of B₂O₃, 11.0 mass % of Al₂O₃, 0.05 mass % of Fe₂O₃, 0.1 mass % of Na₂O, 2 mass % of MgO, 3 mass % of Cao, 15.0 mass % of BaO and 6.5 mass % of SrO. The eluted amounts (unit: mg/cm²) in the tests on water resistance, acid resistance and alkali resistance of this glass, were 0.01, 0.03 and 0.67, respectively.

The inner and outer peripheral edge surfaces of the above doughnut-type glass substrate were subjected to finish polishing with diamond abrasive grains smaller than #500 mesh, and further subjected to mirror finish processing with cerium oxide, so that the concentricity of the inner and outer peripheries (the distance between the centers of the inner peripheral circle and the outer peripheral circle) would be not more than 25 μm. Then, such a glass substrate was subjected to lapping with alumina abrasive grains having an average particle size of 9 μm and polished until the thickness became about 0.7 mm. Such a glass plate was further immersed in a hydrofluoric sulfuric acid solution containing 5% each of hydrofluoric acid and sulfuric acid, for 10 minutes to carry out etching treatment to an etching depth of about 25 μm.

Then, a xylene solution (solid content concentration: 7 wt %) of a methylphenyl silicone resin (“KR311”, tradename, manufactured by Shin-Etsu Chemical Co., Ltd.) as a silicone resin type coating composition, was brush-coated on the inner and outer peripheral edge surfaces of the etching-treated glass plate. Then, it was dried in an oven at from 210 to 220° C. for from 20 to 30 minutes and then cured in an oven at 350° C. for 30 minutes. The thickness of the coating film thereby formed was from 2 to 3 μm on the average.

Then, the front and back main surfaces of the glass substrate for magnetic disks provided with this protective film were subjected to polishing with cerium oxide having an average particle size of 2.5 μm so that the thickness of the substrate was about 0.635 mm. At that time, the coating film extended beyond the inner and outer peripheral edge surfaces was also removed.

This doughnut-type glass substrate (silicone resin coated product) was subjected to the following damaging test. The number of samples was 5. For the purpose of comparison, the following damaging test was carried out also on a doughnut-type glass substrate (non-coated product, referred to as Sample No. 10, Comparative Example) which was obtained in the same manner as the above process, and which was subjected to the etching treatment but on which no coating of the silicone resin type coating composition was carried out. The numbers of samples of Sample Nos. 1 and 10 were respectively 5. The results of the damaging test on these samples, i.e. the average of the breaking stresses (unit: kgf/mm²) of the respective samples are shown in Table 1.

The minimum and the average of the breaking stress of the silicone resin coated product in Example (Sample No. 1) of the present invention were 12.8 and 27.9, respectively, whereas these of the non-coated product in Comparative Example (Sample No. 10) were 9.3 and 12.7, respectively. Thus, the strength of the coated product is evidently higher.

### EXAMPLE 2

Using the same glass A as in Example 1, a doughnut-type glass substrate having an outer diameter of 65 mm, an inner diameter of 20 mm and a thickness of 0.9 mm was prepared. The doughnut-type glass substrate was subjected to finish polishing, lapping and etching treatment in the same manner as in Example 1.

A N-methyl-2-pyrrolidone solution (solid content concentration: 20 wt %) of a polyimide resin (“Pyralin PI2611”, tradename, manufactured by HD MicroSystems Ltd.) as a polyimide resin type coating composition was brush-coated on the etching-treated inner peripheral edge surface of the doughnut-type glass substrate. Then, it was dried in an oven at from 210 to 220° C. for from 20 to 30 minutes and then cured in an oven at 350° C. for 30 minutes. The thickness of the protective film thereby formed was from 2 to 3 μm on the average. The sample thus obtained will be referred to as Sample No. 2.

This doughnut-type glass substrate (polyimide resin coated product) was subjected to the similar damaging test. For the purpose of comparison, the damaging test was carried out also on a doughnut-type glass substrate (non-coated product, referred to as Sample No. 11, Comparative Example) which was obtained in the same manner as the above process, and which is subjected to etching treatment but on which no coating of the polyimide resin type coating composition was carried out. The numbers of samples of Sample Nos. 2 and 11 were respectively 5. The results of the damaging test i.e. the breaking stresses (unit: kgf/mm²) are shown in Table 2.

The minimum and the average of the breaking stress of the polyimide resin coated product in Example (Sample No. 2) of the present invention were 25.2 and 40.7, respectively, whereas these of the non-coated product in Comparative Example (Sample No. 11) were 9.2 and 13.2, respectively. Thus, the stress of the coated product is evidently higher.

Damaging test: A cylindrical bar made of stainless steel (diameter: 8 mm) was passed through the inner peripheral portion of the doughnut-type glass substrate, and the sample was dropped down from a position with a height of 5 mm from the surface of the inner peripheral portion of the glass substrate to the surface of the bar, to impart an impact on the inner peripheral portion of the glass substrate. This operation was repeated 20 times while changing the position of the inner peripheral portion to which the impact was applied.

The breaking stress of the sample thus damaged, was measured by a strength tester (AUTOGRAPH, tradename) manufactured by Shimadzu Corporation. Namely, a stainless steel ball having a diameter of 36 mm was set on the inner periphery of the sample, and the sample was pressed by the ball at a pressing rate of 30 mm/min to breakage, whereupon the breaking stress was calculated from the load at the time of breakage of the sample detected by a load cell.

TABLE 1

| | 1 | 2 | 3 | 4 | 5 | Average |
|---|---|---|---|---|---|---|
| Silicone resin | | | | | | |
| coated product | | | | | | |
| (Sample No. 1) | | | | | | |
| Breaking stress | 36.5 | 12.8 | 29.7 | 46 | 14.7 | 27.9 |
| Non-coated | | | | | | |
| product | | | | | | |
| (Sample No. 10) | | | | | | |
| Breaking stress | 19.6 | 11.3 | 9.3 | 11.3 | 11.8 | 12.7 |

TABLE 2

| | 1 | 2 | 3 | 4 | 5 | Average |
|---|---|---|---|---|---|---|
| Polyimide | | | | | | |
| coated product | | | | | | |
| (Sample No. 2) | | | | | | |
| Breaking stress | 49.5 | 30.2 | 60.3 | 38.4 | 25.2 | 40.7 |
| Non-coated | | | | | | |
| product | | | | | | |
| (Sample No. 11) | | | | | | |
| Breaking stress | 18.2 | 10.1 | 16.5 | 12.1 | 9.2 | 13.2 |

### EXAMPLE 3

Using the same glass A as in Example 1, a disk-shape glass substrate having an outer diameter of 65 mm and a thickness of 0.9 mm (no inner hole) was prepared. The outer peripheral edge surface of the disk-shape glass substrate was subjected to finish polishing with diamond abrasive grains smaller than #500 mesh, and further subjected to mirror finish processing with cerium oxide. Then, lapping with alumina abrasive grains having an average particle size of 9 μm was carried out to polish the main surface of the disk-shape glass substrate until the thickness became about 0.7 mm. The glass plate was further immersed in a hydrofluoric sulfuric acid solution containing 5% each of hydrofluoric acid and sulfuric acid, for 10 minutes to carry out etching treatment on the entire disk-shape glass substrate to an etching depth of about 12.5 μm.

Then, a xylene solution (solid content concentration: 7 wt %) of a methylphenyl silicone resin (“KR282”, tradename, manufactured by Shin-Etsu Chemical Co., Ltd.) as a silicone resin type coating composition, was brush-coated on the main surface of the etching-treated glass plate. Then, it was dried in an oven at from 210 to 220° C. for from 20 to 30 minutes and then cured in an oven at 350° C. for 30 minutes. The thickness of the coating film thereby formed was from 2 to 3 μm on the average. The sample thus obtained will be referred to as Sample No. 3. The number of samples of Sample No. 3 was 5.

### EXAMPLE 4

Using the same glass A as in Example 1, a disk-shape glass substrate having an outer diameter of 65 mm and a thickness of 0.9 mm (no inner hole) was prepared. The outer peripheral edge surface of the disk-shape glass substrate was subjected to finish polishing with diamond abrasive grains smaller than #500 mesh, and further subjected to mirror finish processing with cerium oxide. Then, lapping with alumina abrasive grains having an average particle size of 9 μm was carried out to polish the main surface of the disk-shape glass substrate until the thickness became about 0.7 mm. The glass plate was further immersed in a hydrofluoric sulfuric acid solution containing 5% each of hydrofluoric acid and sulfuric acid, for 10 minutes to carry out etching treatment on the entire disk-shape glass substrate to an etching depth of about 12.5 μm.

Then, a N-methyl-2-pyrrolidone solution (solid content concentration: 20 wt %) of a polyimide resin (“Pyralin P9186”, tradename, manufactured by HD MicroSystems Ltd.) as a polyimide resin type coating composition was brush-coated on the main surface of the etching-treated glass plate. Then, it was dried in an oven at from 210 to 220° C. for from 20 to 30 minutes, and then cured in an oven at 350° C. for 30 minutes. The thickness of the protective film thereby formed was from 2 to 3 μm on the average. The sample thus obtained will be referred to as Sample No. 4. The number of samples of Sample No. 4 was 5.

For the purpose of comparison, the outer peripheral edge surface of the above disk-shape glass substrate was subjected to finish polishing with diamond abrasive grains smaller than #500 mesh, and further subjected to mirror finish processing with cerium oxide. Then, lapping with alumina abrasive grains having an average particle size of 9 μm was carried out to polish the main surface of the disk-shape glass substrate until the thickness became about 0.7 mm to obtain Sample No. 12 (Comparative Example, sample without etching treatment nor coating treatment).

Further, the outer peripheral edge surface of the above disk-shape glass substrate was subjected to finish polishing with diamond abrasive grains smaller than #500 mesh, and further subjected to mirror finish processing with cerium oxide. Then, lapping with alumina abrasive grains having an average particle size of 9 μm was carried out to polish the main surface of the disk-shape glass substrate until the thickness became about 0.7 mm. The glass plate was further immersed in a hydrofluoric sulfuric acid solution containing 5% each of hydrofluoric acid and sulfuric acid, for 10 minutes to carry out etching treatment on the entire disk-shape glass substrate to an etching depth of about 12.5 μm to obtain Sample No. 13 (Comparative Example, a sample with etching treatment with no coating treatment).

Further, the outer peripheral edge surface of the above disk-shape glass substrate was subjected to finish polishing with diamond abrasive grains smaller than #500 mesh, and further subjected to mirror finish processing with cerium oxide. Then, lapping with alumina abrasive grains having an average particle size of 9 μm was carried out to polish the main surface of the disk-shape glass substrate until the thickness became about 0.7 mm. Then, a xylene solution (solid content concentration: 7 wt %) of a methylphenyl silicone resin (“KR282”, tradename, manufactured by Shin-Etsu Chemical Co., Ltd.) as a silicone resin type coating composition was brush-coated on the main surface of the disk-shape glass plate. Then, it was dried in an oven at from 210 to 220° C. for from 20 to 30 minutes and then cured in an oven at 350° C. for 30 minutes. The thickness of the protective film thereby formed was from 2 to 3 μm on the average. Sample No. 14 (Comparative Example, a sample with no etching treatment with coating treatment) was thus obtained.

These Sample Nos. 3 and 4 and Sample Nos. 12, 13 and 14 were subjected to the following falling ball test.

Falling ball test: An iron ball having a mass of 5.5 g was dropped down on the center of the sample from a height of 0 mm and from a height of 8 mm, and the breaking strength of the sample at the time of dropping was measured by a strength tester (AUTOGRAPH, tradename) manufactured by Shimadzu Corporation. The results are shown in Table 3. As the breaking strength, the average value is shown. The number of samples is as disclosed in Table 3.

As evident from the results of the falling ball test on Sample No. 3 in Example, the breaking strength is 148.0 kgf when the falling ball height is 0 mm, whereas it is 136.9 kgf when the falling ball height is 8 mm. Further, as evident from the results of the falling ball test on Sample No. 4, the breaking strength is 185.9 kgf when the falling ball height is 0 mm, whereas it is 160.3 kgf when the falling ball height is 8 mm. Accordingly, the proportions of the decrease in the strength are 7.5% and 13.8%, respectively, such being small. On the other hand, the proportions of the decrease in the strength are 64.7%, 45.7% and 64.7% with respect to Sample Nos. 12, 13 and 14 in Comparative Examples, respectively. Accordingly, the proportions of the decrease in the strength are remarkably large as compared with the products of Sample No. 3, No. 4 with etching treatment and coating treatment.

TABLE 3

| | Falling | | Average |
|---|---|---|---|
| | ball | Number | breaking |
| | height | of | strength |
| Samples | (mm) | samples | (kgf) |
| Sample No. 3 (with | 0 | 13 | 148.0 |
| etching treatment and | | | |
| coating treatment) | | | |
| Sample No. 3 | 8 | 14 | 136.9 |
| Sample No. 4 (with | 0 | 15 | 185.9 |
| etching treatment and | | | |
| coating treatment) | | | |
| Sample No. 4 | 8 | 14 | 160.3 |
| Sample No. 12 | 0 | 19 | 19.0 |
| (Comparative Example) (no | | | |
| etching treatment nor | | | |
| coating treatment) | | | |
| Sample No. 12 | 8 | 20 | 6.7 |
| (Comparative Example) (no | | | |
| etching treatment nor | | | |
| coating treatment) | | | |
| Sample No. 13 | 0 | 12 | 29.3 |
| (Comparative Example) | | | |
| (with etching treatment, | | | |
| no coating treatment) | | | |
| Sample No. 13 | 8 | 11 | 15.9 |
| (Comparative Example) | | | |
| (with etching treatment, | | | |
| no coating treatment) | | | |
| Sample No. 14 | 0 | 18 | 30.1 |
| (Comparative Example) (no | | | |
| etching treatment, with | | | |
| coating treatment) | | | |
| Sample No. 14 | 8 | 19 | 10.6 |
| (Comparative Example) (no | | | |
| etching treatment, with | | | |
| coating treatment) | | | |

The present invention provides a glass substrate for magnetic disks having high strength to be used for production of magnetic disks, without employing a chemical reinforcing method. The glass substrate for magnetic disks has a protective film having excellent characteristics formed on the inner peripheral edge surface, or on the inner peripheral edge surface and the outer peripheral edge surface, and has these surfaces smoothened. Accordingly, generation of particles from the edge surfaces which may cause thermal asperities can be prevented.

The entire disclosure of Japanese Patent Application No. 2003-422711 filed on Dec. 19, 2003 including specification, claims and summary is incorporated herein by reference in its entirety.

1. A glass substrate for magnetic disks, which is a doughnut-type glass substrate with its inner peripheral edge surface etching-treated, wherein the etching-treated inner peripheral edge surface is coated with a silicone resin or a polyimide.

2. A glass substrate for magnetic disks, which is a doughnut-type glass substrate with its inner peripheral edge surface and outer peripheral edge surface etching-treated, wherein the etching-treated inner peripheral edge surface and outer peripheral edge surface are coated with a silicone resin or a polyimide.

3. A process for producing a glass substrate for magnetic disks, which comprises subjecting at least the inner peripheral edge surface of a doughnut-type glass substrate to etching treatment, and then coating the etching-treated inner peripheral edge surface of the doughnut-type glass substrate with a silicone resin or a polyimide.

4. A process for producing a glass substrate for magnetic disks, which comprises subjecting at least the inner peripheral edge surface and the outer peripheral edge surface of a doughnut-type glass substrate to etching treatment, and then coating the etching-treated inner peripheral edge surface and outer peripheral edge surface of the doughnut-type glass substrate with a silicone resin or a polyimide.

5. A process for producing a glass substrate for magnetic disks, which comprises coating a coating composition containing a silicone resin or a polyimide, on at least the inner peripheral edge surface of a doughnut-type glass substrate having at least its inner peripheral edge surface etching-treated, followed by curing to form a protective film, and polishing the main surface of the doughnut-type glass substrate.
